(19) United States
(12) Patent Application Publication
(10) Pub. No.: US 2026/0261102 A1
(43) Pub. Date: Sep. 3, 2026

(54) MULTIPART COUPLER FOR RETROFIT OF MICROGRID INTERCONNECTION DEVICE (MID)

(71) Applicant: EATON INTELLIGENT POWER LIMITED, Dublin (IE)

(72) Inventors: Suhas Vishwanath Dhakate, Pune (IN); Mahesh Ighe, Pune (IN); Sandip Nagtilak, Pandharpur (IN)

(73) Assignee: EATON INTELLIGENT POWER LIMITED, DUBLIN (IE)

(21) Appl. No.: 19/067,046

(22) Filed: Feb. 28, 2025

(51) Int. Cl. H02B 13/00; H02B 1/46; H02B 1/56

(52) U.S. Cl. CPC H02B 13/005; H02B 1/46; H02B 1/56

(57) ABSTRACT

A multipart coupler provides structural support and thermal management for the retrofit installation of a microgrid interconnection device (MID) in a meter breaker. The multipart coupler forms paths that conduct heat from the electrical joints between the MID and meter breaker to the meter breaker housing, and includes three individual couplers: a Line1 (L1) coupler connecting the MID to the meter breaker grid side L1 main terminal, a Line2 (L2) coupler connecting the MID to the meter breaker grid side L2 main terminal, and a load L1/L2 coupler for connecting the MID L1 and L2 load sides to the meter breaker branch bus. Each coupler gets installed in the meter breaker separately from the other two couplers. Next, an alignment template formed based on the MID structure is seated onto all three individual couplers, thus forming the complete multipart coupler. Last, the MID gets seated onto the complete multipart coupler.

### FIELD OF THE INVENTION

The disclosed concept relates generally to microgrid interconnection devices (MIDs), and in particular, to thermal management devices and systems for MIDs.

### BACKGROUND OF THE INVENTION

DER (distributed energy resource) systems are relatively small-scale power sources that generate electricity on-site for individual electricity consumers and can be interconnected to the utility electrical grid. DERs enable a consumer to supplement and sometimes replace their use of utility power and can also sometimes supply/backfeed power to the utility grid. A microgrid interconnection device (MID) is a device used to monitor and manage a microgrid’s connection and disconnection between a utility power source and DER systems. MIDs must comply with applicable safety standards such as UL 67, which is directed to service entrance safety requirements.

An MID can be retrofitted for use with an existing meter breaker, but there are various electrical safety standards that must be met. UL67 states that no modifications can be made within an existing meter breaker enclosure to accommodate retrofit device additions, however, UL listed accessories and fitments are permitted to be added to an existing meter breaker. In order for a given accessory or fitment to receive UL listing, the accessory/fitment must ensure that the temperature of the busbar joins, the temperature of the main breaker lug, and the temperature of the branch breaker input and output terminals are bounded within defined temperature rises listed in UL 67, Table 21.1.

Retrofitting an MID for use with an existing meter breaker adds sources of heat to the meter breaker and increases the temperature of devices in the meter breaker such as the main breaker, the branch breaker busbar, and all associated joints. The MID relay in particular is a significant source of added heat. Accordingly, a heat management solution is needed to mitigate any increase in heat caused by adding a retrofit MID to an existing meter breaker, but there are significant space constraints that limit the viable heat management options, as the existing meter breaker structure was not designed to account for installation of either the MID or any heat management solution that is necessitated by installing the MID in the meter breaker.

There is thus room for improvement in thermal management devices and systems for MIDs that are retrofit for use in existing meter breakers.

### SUMMARY OF THE INVENTION

These needs, and others, are met by embodiments of a multipart coupler designed for use in the retrofit installation of an MID into a meter breaker, in order to structurally support the MID and conduct heat away from the electrical joints between the MID and the meter breaker. The multipart coupler forms multiple paths that conduct heat from the electrical joints between the MID and meter breaker to the meter breaker housing, and includes three individual couplers: a Line 1 (L1) coupler connecting the MID to the grid side L1 main terminal of the meter breaker, a Line 2 (L2) coupler connecting the MID to the grid side L2 main terminal of the meter breaker, and a load L1/L2 coupler for connecting the L1 and L2 MID load sides to the branch bus of the meter breaker. Each individual coupler gets installed in the meter breaker separately from the other two individual couplers. Next, an alignment template formed based on the MID structure is seated onto all three individual couplers, thus forming the complete multipart coupler. Last, the MID gets seated onto the complete multipart coupler.

In accordance with one aspect of the disclosed concept, a multipart coupler is provided for use in installing a retrofit MID into a meter breaker having a meter breaker housing. The multipart coupler comprises three component couplers and an alignment template, with the alignment template structured to be simultaneously coupled to the three component couplers. The three component couplers include: a main L1 coupler structured to be coupled to a main L1 terminal on a grid side of the meter breaker; a main L2 coupler structured to be coupled to a main L2 terminal on a grid side of the meter breaker; and a load L1/L2 coupler structured to be coupled to a load side L1 terminal and a load side L2 terminal on a load side of the meter breaker. The main L1 coupler is structured to form a grid side L1 thermal conduction path from a joint formed at the main L1 terminal to the meter breaker housing, and the main L2 coupler is structured to form a grid side L2 thermal conduction path from a joint formed at the main L2 terminal to the meter breaker housing. The load L1/L2 coupler is structured to form a load side L1 thermal conduction path and a load side L2 thermal conduction path, the load side L1 thermal conduction path extending from a joint formed at the load side L1 terminal to the meter breaker housing, and the load side L2 thermal conduction path being from a joint formed at the load side L2 terminal to the meter breaker housing.

### BRIEF DESCRIPTION OF THE DRAWINGS

A full understanding of the invention can be gained from the following description of the preferred embodiments when read in conjunction with the accompanying drawings in which:

FIGS. 1A-1D are front elevational views of the interior of an existing meter breaker, showing the stages of installing a retrofit MID into the existing meter breaker and installing a newly disclosed multipart coupler for thermal management into the existing meter breaker, in accordance with an exemplary embodiment of the disclosed concept, while FIG. 1E shows a dead front cover enclosing the interior of the meter breaker after the installation of the retrofit MID and the newly disclosed multi-part coupler is complete;

FIG. 2A and FIG. 2B are respectively a perspective view of the retrofit MID shown in FIG. 1D being positioned for seating onto the newly disclosed multipart coupler shown in FIG. 1C and a perspective view of the MID after being seated onto the newly disclosed multipart coupler, in accordance with an exemplary embodiment of the disclosed concept;

FIG. 3 is a perspective view of the newly disclosed multipart coupler, showing an alignment template of the multipart coupler being positioned for seating onto three component couplers of the multipart coupler and then being seated onto the three component couplers, in accordance with an exemplary embodiment of the disclosed concept;

FIG. 4 is a perspective view of the three component couplers clustered together prior to the alignment template of FIG. 3 being seated upon the three component couplers, and further provides an exploded view enabling each of the three couplers to be viewed individually;

FIG. 5A is a perspective view of two heat spreaders of the load side coupler of the multipart coupler;

FIG. 5B is a top elevational view of a wall engaging section of the two heat spreaders shown in FIG. 5A;

FIG. 6 is an elevational view from the perspective of the bottom of the meter breaker, showing the thermal conduction paths created by the multipart coupler between the MID and meter breaker electrical joints to the walls of the meter breaker housing, in accordance with an exemplary embodiment of the disclosed concept;

FIG. 7A is a perspective view of a heat conduction block having laminated busbar walls that can be used in the line side couplers shown in FIG. 4, in accordance with another example embodiment of the disclosed concept; and

FIG. 7B is a side elevational view of the heat conduction block shown in FIG. 7A.

### DETAILED DESCRIPTION OF THE INVENTION

Directional phrases used herein, such as, for example, left, right, front, back, top, bottom and derivatives thereof, relate to the orientation of the elements shown in the drawings and are not limiting upon the claims unless expressly recited therein.

As employed herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other.

As employed herein, when ordinal terms such as “first” and “second” are used to modify a noun, such use is simply intended to distinguish one item from another, and is not intended to require a sequential order unless specifically stated.

As employed herein, the term “number” shall mean one or an integer greater than one (i.e., a plurality).

Described herein are embodiments of an innovative multipart structural support and heat management coupler 100 (referred to hereinafter as the “multipart coupler 100”), disclosed in accordance with an example embodiment of the disclosed concept. The multipart coupler 100 is advantageously designed to provide structural support to a retrofitted MID 50 that is installed in an existing meter breaker 10 and to provide a heat management solution to dissipate additional heat generated in the meter breaker 10 when the retrofit MID 50 is installed.

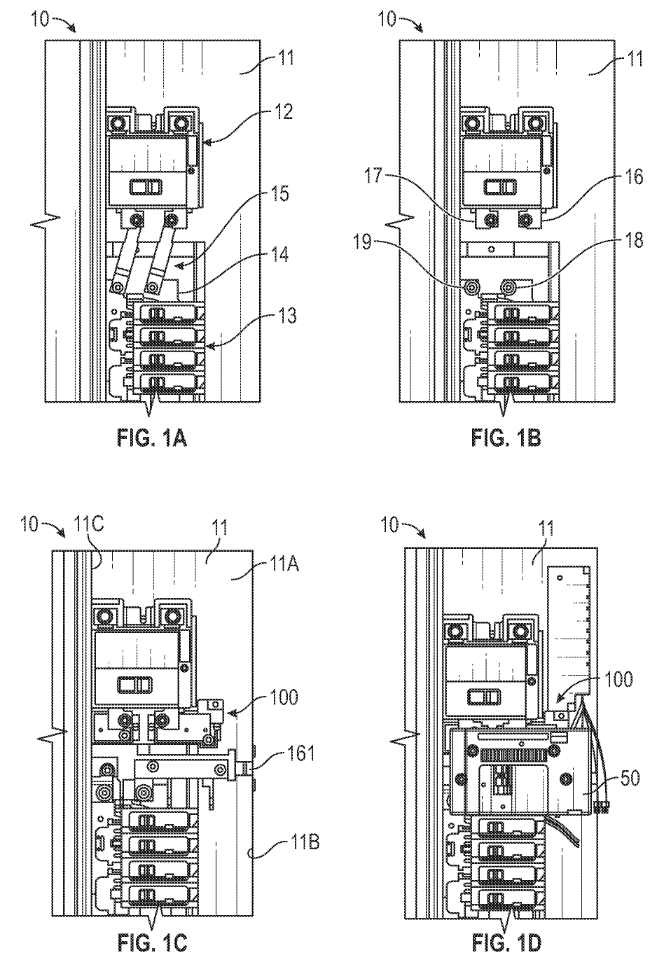

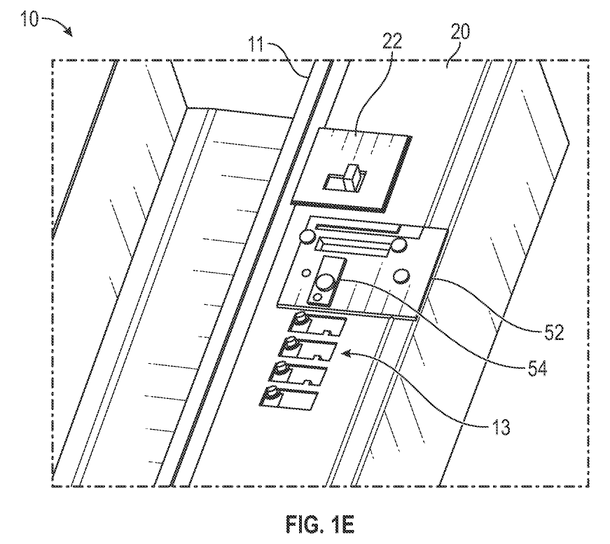

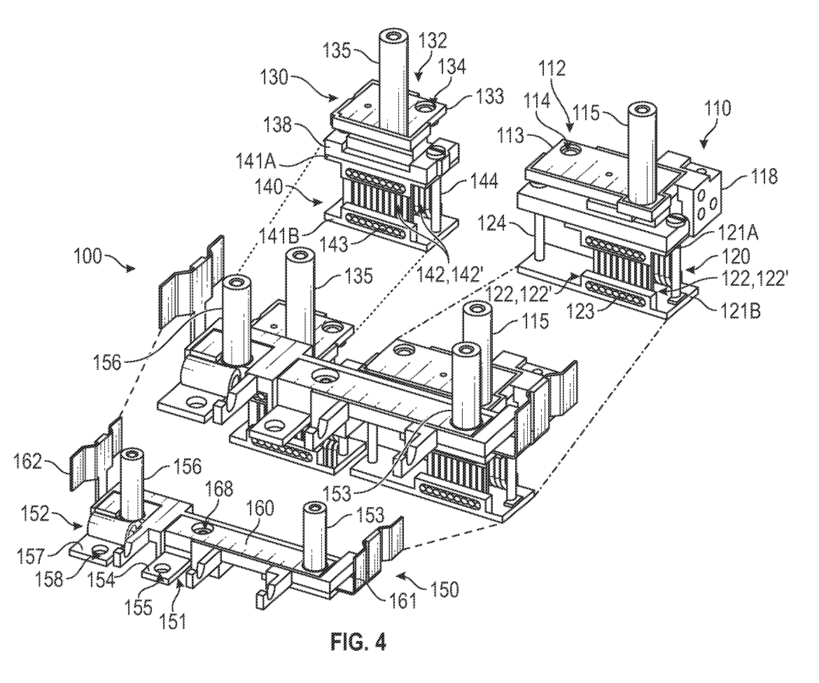

FIGS. 1A-1E show the various stages of installing the retrofit MID 50 and the newly disclosed multipart coupler 100 into the existing meter breaker 10, and FIG. 1E shows the meter breaker 10 with its dead front cover enclosing the interior of the meter breaker 10 after installation of the retrofit MID 50 and the multipart coupler 100 is complete. As shown in FIG. 1A, the meter breaker 10 in its original form comprises a housing 11 that houses a main circuit breaker 12 and a plurality of branch circuit breakers 13 connected to a branch bus 14. The main circuit breaker 12 and branch circuit breakers 13 are referred to hereinafter as the “main breaker 12” and “branch breakers 13” for brevity. The branch bus 14 is connected to the main breaker 12 by jumper busbars 15. As shown in FIG. 1B, the jumper busbars 15 must be removed from the meter breaker 10 to prepare for installation of the retrofit MID 50 and the multipart coupler 100 into the meter breaker 10. When the jumper busbars 15 are removed, a main L1 (Line 1) terminal 16, a main L2 (Line 2) terminal 17, a load side L1 (Line 1) terminal 18, and a load side L2 (Line 2) terminal 19 become accessible. The main L1 and main L2 terminals 16, 17 are connected to the main breaker 12, and the load side L1 and L2 terminals 18, 19 are connected to the branch bus 14. As shown in FIG. 1C, the multipart coupler 100 can be installed in the meter breaker 10 after the removal of the jumper busbars 15. As detailed further later herein, the multipart coupler 100 gets coupled to each of the main L1, main L2, load side L1, and load side L2 terminals 16, 17, 18, 19. In FIG. 1C, a rear wall 11A, a first side wall 11B, and a second side wall 11C of the housing 11 are numbered, which will be discussed further later herein in connection with FIG. 4.

As shown in FIG. 1D, the MID 50 can be installed in the meter breaker 10 after the multipart coupler 100 is installed. It is noted that the MID 50 and multipart coupler 100 are structured to connect the main breaker 12 to the branch bus 14 via connections made through the multipart coupler 100 and the MID 50, as will become apparent later herein. As shown in FIG. 1E, the MID 50 and multipart coupler 100 are structured to ensure that a dead front cover 20 of the meter breaker 20 can be reattached to the rest of the housing 11 to properly enclose the interior of the meter breaker 10 after installation of the MID 50 and the multipart coupler 100. FIG. 1E also shows a main breaker front cover 22 and an MID front cover 52 attached to the dead front cover 20 in order to respectively cover the main breaker 12 and the MID 50. It is noted that the MID front cover 52 includes a manual override switch 54 for the MID 50.

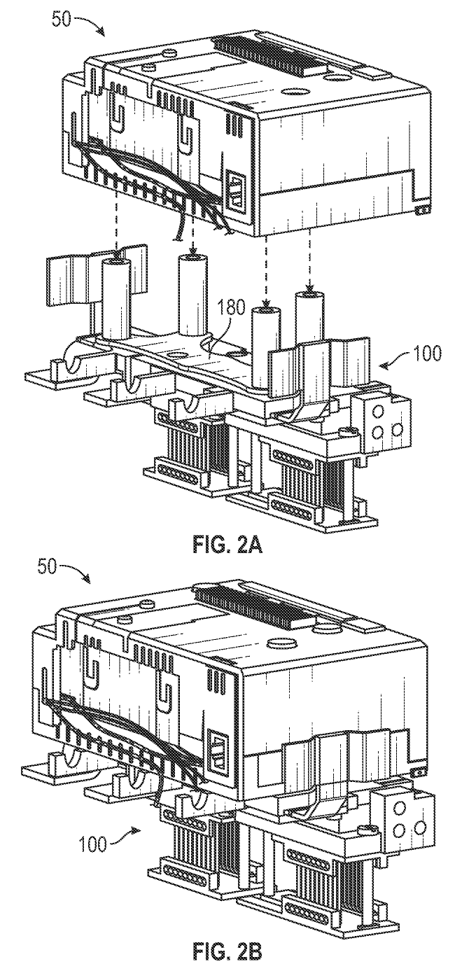

FIG. 2A shows the MID 50 being positioned to be seated on the multipart coupler 100, and FIG. 2B shows the MID 50 seated on the multipart coupler 100. It will be appreciated from viewing FIG. 2B that the multipart coupler 100 provides structural support for the MID 50 within the meter breaker 10. As detailed further hereinafter primarily in connection with FIG. 4, the multipart coupler 100 comprises three separate component couplers 110, 130, 150 and an alignment template 180. In addition to providing structural support for installation of the retrofit MID 50 in the meter breaker 10, the multipart coupler 100 further provides thermal management to conduct heat away from the electrical joints between the MID 50 and the meter breaker 10.

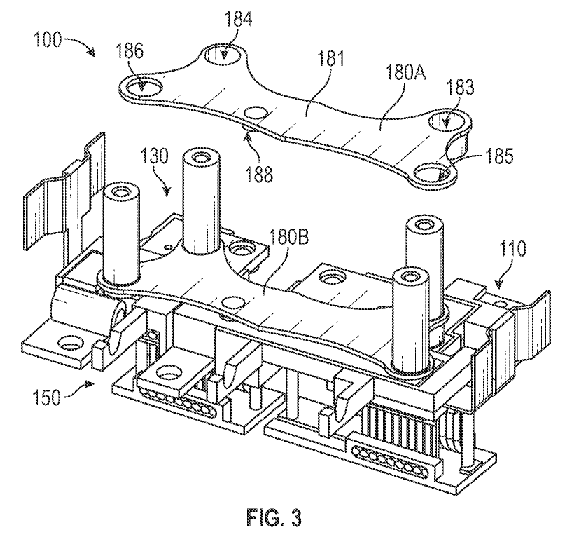

Each of the couplers 110, 130, 150 and the alignment template 180 are produced separately, with the alignment template 180 being used to couple the couplers 110, 130, 150 together, as detailed further later herein. Coupling the three couplers 110, 130, 150 together with the alignment template 180 ensures that the couplers 110, 130, 150 are precisely positioned relative to each other so that various seating features included on the couplers 110, 130, 150 are properly aligned with the relevant connection points on the MID 50 that enable the multipart coupler 100 to securely seat the MID 50 and properly connect the electrical terminals of the MID 50 to the corresponding electrical terminals of the meter breaker 10. The alignment template 180 is shown in FIG. 3. In FIG. 3, two different points in time are simultaneously depicted. The alignment template 180 that is numbered 180A in FIG. 3 depicts the time when the alignment template 180 is being positioned for insertion onto the three couplers 110, 130, 150, and the alignment template 180 that is numbered 180B in FIG. 3 depicts the time after the alignment template 180 has been inserted onto the three couplers 110, 130, 150.

Reference is now made to FIG. 4 to describe the components of the multipart coupler 100 in detail. As previously stated, the multipart coupler 100 comprises three couplers produced separately prior to being coupled together by the alignment template 180: a main grid side L1 coupler 110, a main grid side L2 coupler 130, and a load L1/L2 coupler 150. The main grid side L1 coupler 110 is structured to be coupled to the main L1 terminal 16 (FIG. 1B). The main grid side L2 coupler 130 is structured to be coupled to the main L2 terminal 17 (FIG. 1B). The load L1/L2 coupler 150 is structured to be coupled to both of the load side L1 and L2 terminals 18, 19 (FIG. 1B).

The main grid side L1 coupler 110 is referred to hereinafter as the “main L1 coupler 110” for brevity and the main grid side L2 coupler 130 is referred to hereinafter as the “main L2 coupler 130” for brevity. Both of the main L1 and main L2 couplers 110, 130 comprise the same types of components, but each component within each coupler 110, 130 is structured somewhat differently relative to the corresponding component in the other coupler 130, 110 due to the fact that the main L1 coupler 110 has to be structured specifically to be coupled between the main L1 terminal 16 and a grid side L1 terminal on the MID 50 (said terminal on the MID 50 not being visible in the figures), while the main L2 coupler 130 has to be structured specifically to be coupled between the main L2 terminal 17 and a grid side L2 terminal on the MID 50 (said terminal on the MID 50 not being visible in the figures).

Each coupler 110, 130 respectively comprises a grid-to-MID pathway portion 112, 132. The entire grid-to-MID pathway portion 112, 132 is electrically conductive, and can be produced from copper, for example and without limitation. Each grid-to-MID pathway portion 112, 132 respectively comprises: (1) a grid connection portion 113, 133 with a fastening aperture 114, 134 formed therein, and (2) an MID-L1 connecting socket 115 (for the coupler 110) or an MID-L2 connecting socket 135 (for the coupler 130) extending from the grid connection portion 113, 133. Each fastening aperture 114, 134 is structured to receive a fastener (such as a clinch nut, for example and without limitation) in order to connect the respective coupler 110, 130 to the corresponding main L1 or L2 terminal 116, 117. Specifically, a fastener can be inserted through the fastening aperture 114 in order to couple the main L1 coupler 110 to the main L1 terminal 116. Similarly, a fastener can be inserted through the fastening aperture 134 in order to couple the main L2 coupler 130 to the main L2 terminal 117. Each MID-L1 or MID-L2 connecting socket 115, 135 is structured to be inserted into a corresponding conductive terminal (not visible in the figures) in the MID 50, in order to connect the MID 50 to the main L1 terminal 116 through the main L1 coupler 110 and in order to connect the MID 50 to the main L2 terminal 117 through the main L2 coupler 130.

Each coupler 110, 130 respectively further comprises an electrically insulative overmold 118, 138 and a heat conduction block 120, 140. The overmolds 118, 138 can be made from plastic, for example and without limitation. Each overmold 118, 138 is connected between the respective grid-to-MID pathway portion 112, 132 and the respective heat conduction block 120, 140. Each overmold 118, 138 is directly coupled to the respective grid connection portion 113, 133 such that the MID-L1 or MID-L2 connecting socket 115, 135 extends from the grid connection portion 113, 133 away from the overmold 118, 138.

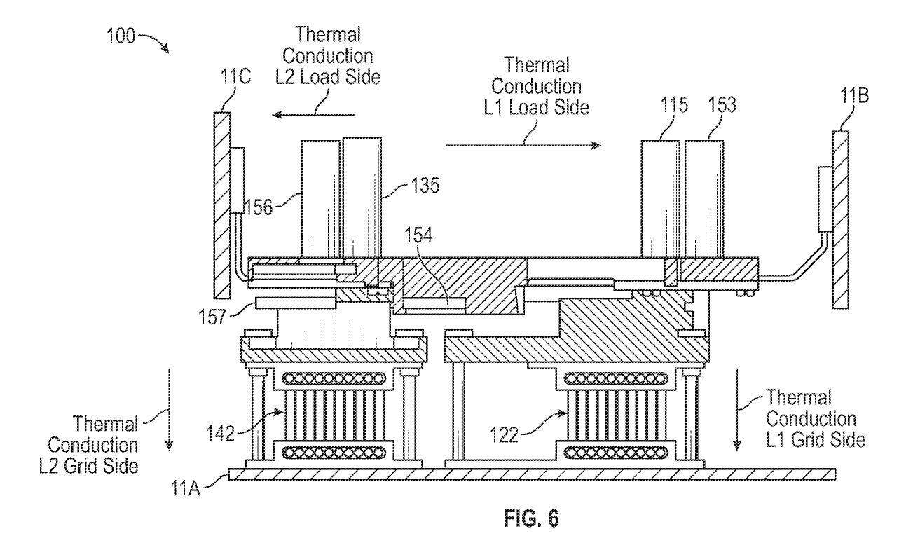

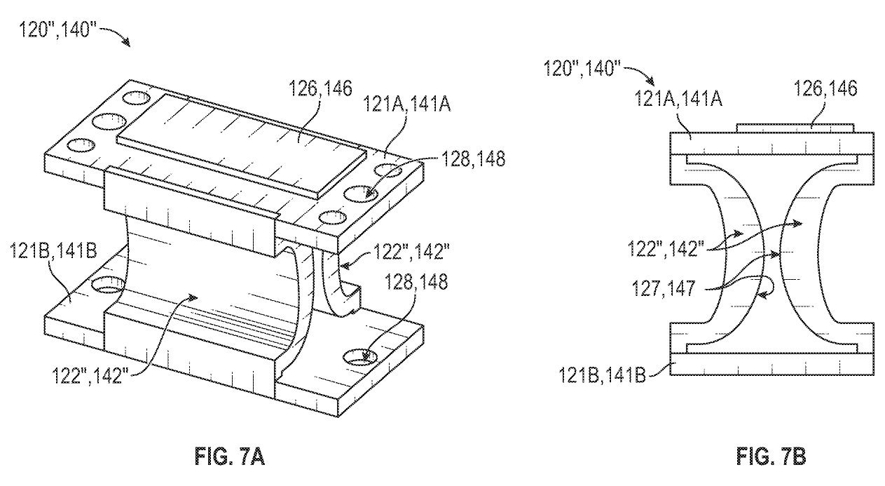

Each heat conduction block 120, 140 respectively comprises a planar proximal conduction plate 121A, 141A, a planar distal conduction plate 121B, 141B, and a number of busbar walls 122, 142 extending from the proximal conduction plate 121A, 141A to the distal conduction plate 121B, 141B. The proximal conduction plate 121A, 141A is coupled to the overmold 118, 138. For each heat conduction block 120, 140, the distal conduction plate 121B, 141B is the portion of the conduction block 120, 140 disposed furthest from the overmold 118, 138. Each busbar wall 122, 142 can be either a braided busbar wall 122´,142´ or a laminated busbar wall 122´´,142´´, the braided busbar walls 122´,142´ being shown in FIGS. 4 and 6, and the laminated busbar walls 122´´,142´´ being shown in FIGS. 7A-7B. Each braided busbar wall 122´,142´ and each laminated busbar wall 122´´,142´´ can be referred to generally using the reference number 122, 142. From a thermal conduction perspective, the braided busbar wall 122´,142´ and the laminated busbar wall 122´´,142´´ perform similarly to one another within the overall structure of the multipart coupler 100, and it is noted that either embodiment (i.e. braided or laminated) can be used in the multipart coupler 100 without departing from the scope of the disclosed concept. While the heat conduction blocks 120, 140 are initially discussed as comprising braided busbar walls 122´,142´, a discussion of the features of the laminated busbar wall 122´´,142´´ is provided later herein in conjunction with FIGS. 7A and 7B.

When each busbar wall 122, 142 is a braided busbar wall 122´,142´, then each braided busbar wall 122´, 142´ respectively comprises a plurality of individual braided busbars 123, 143 positioned adjacent to one another. While the heat conduction blocks 120, 140 are depicted in the figures as each including two busbar walls 122, 142, it is noted that the conduction blocks can comprise only one or more than two busbar walls 122, 142 without departing from the scope of the disclosed concept. The braided busbars 123, 143 can be made from any thermally conductive material, such as copper, for example and without limitation.

Referring briefly to FIG. 1C, as previously noted, the meter breaker housing 11 comprises a rear wall 11A. The distal conduction plate 121B, 141B of each respective coupler 110, 130 is structured to engage the rear wall 11A of the housing 11 when the coupler 110, 130 is coupled to the main L1 terminal 116 or main L2 terminal 117. As will become apparent, it is desirable to maximize the surface area contact between each distal conduction plate 121B, 141B and the rear wall 11A. In order to facilitate maximizing the surface area contact between the distal conduction plate 121B, 141B and the rear wall 11A, each coupler 110, 130 further comprises a number of electrically insulative screws 124, 144. The insulative screws 124, 144 can be selectively tightened or loosened as necessary to level the distal conduction plate 121B, 141B against the rear wall 11A in order to maximize contact pressure between the distal conduction plate 121B, 141B and the rear wall 11A. The insulative screws 124, 144 can be made from plastic, for example and without limitation.

When the multipart coupler 100 is installed in the meter breaker 10 between the meter breaker 10 and the MID 50 with the meter breaker 10 and MID 50 powered ON, a significant amount of heat will be generated in the grid-to-MID pathway portions 112, 132 as power is conducted between the meter breaker 10 and the MID 50 (via the conductive paths formed in the grid-to-MID pathway portions 112, 132 between the grid connection portions 113, 133 and the MID-L1 or MID-L2 connecting sockets 115, 135). Each overmold 118, 138 provides electrical isolation between the grid-to-MID pathway portion 112, 132 and the heat conduction blocks 120, 140. Each overmold 118, 138 absorbs some of the heat from the grid-to-MID pathway portion 112, 132 which is then conducted to the proximal conduction plate 121A, 141A, and the busbar walls 122, 142 then conduct heat from the proximal conduction plate 121A, 141A to the distal conduction plate 121B, 141B. It is noted that the greater the number of individual braided busbars 123, 143 is in each braided busbar wall 122´, 142´, the greater the heat conduction away from the grid-to-MID pathway portions 112, 132 will be.

Because the distal conduction plate 121B, 141B engages the rear wall 11A of the meter breaker housing 11, heat is then transferred from the distal conduction plate 121B, 141B to the rear wall 11A, enabling some of the heat to dissipate in the environment external to the meter breaker housing 11. This thermal conduction path to the rear wall 11A from the grid side electrical joints (i.e. the joints formed between the meter breaker 10 and MID 50) is depicted in FIG. 6. It will be appreciated that being able to conduct heat from the interior of the meter breaker housing 11 to the exterior is highly advantageous for minimizing the temperature rise of all of the electrical joints and the environment inside of the housing 11.

The load L1/L2 coupler 150 will now be detailed. The load L1/L2 coupler 150 shares some similarities with the main grid side L1 and L2 couplers 110, 130, but has some differences as well. The coupler 150 comprises an MID-to-L1 load pathway portion 151 (referred to hereafter as the “L1 load pathway portion 151” for brevity) and an MID-to-L2 load pathway portion 152 (referred to hereafter as the “L2 load pathway portion 152” for brevity).

The L1 load pathway portion 151 comprises an MID-L1 load socket 153 and a load bus connection portion 154. It is noted that the MID-L1 load socket 153 and the load bus connection portion 154 are physically connected, although this physical connection is obscured in the figures by an overmold 160 detailed later herein. The load bus connection portion 154 has a fastening aperture 155 formed therein.

The L2 load pathway portion 152 comprises an MID-L2 load socket 156 and a load bus connection portion 157. As can be seen in FIG. 4, the MID-L2 load socket 156 and the load bus connection portion 154 are physically connected. The load bus connection portion 157 has a fastening aperture 158 formed therein.

Each fastening aperture 155, 158 is structured to receive a fastener (such as a clinch nut, for example and without limitation) in order to respectively connect the load L1/L2 coupler 150 to the load side L1 terminal 18 (see FIG. 1B) and the load side L2 terminal 19 (see FIG. 1B). Specifically, a fastener can be inserted through the fastening aperture 155 in order to couple the load L1/L2 coupler 150 to the load side L1 terminal 18 and another fastener can be inserted through the fastening aperture 158 in order to couple the load L1/L2 coupler 150 to the load side L2 terminal 19.

The load L1/L2 coupler 150 further comprises an electrically insulative overmold 160 that is coupled to both the L1 load pathway portion 151 and the L2 load pathway portion 152. The overmold 160 can be made from plastic, for example and without limitation. The load L1/L2 coupler 150 further comprises a heat spreader 161 and a heat spreader 162. In one non-limiting exemplary embodiment, the heat spreaders 161 and 162 are produced from beryllium copper, due to beryllium copper having good thermal conductivity and some degree of flexibility. The overmold 160 is coupled between the heat spreader 161 and the L1 load pathway portion 151, such that the overmold 160 separates the heat spreader 161 and the L1 load pathway portion 151. The overmold 160 is also coupled between the heat spreader 162 and the L2 load pathway portion 152, such that the overmold 160 separates the heat spreader 162 and the L2 load pathway portion 152. The overmold 160 further comprises a template receiving aperture 168 that will be detailed further in the discussion of the alignment template 180 later herein.

Referring briefly to FIG. 1C, as previously noted, the meter breaker housing 11 comprises a first side wall 11B and a second side wall 11C. Each heat spreader 161, 162 is structured to engage the respective side wall 11B, 11C when the load L1/L2 coupler 150 is coupled to the MID 50 and the load side L1 and L2 terminals 18, 19. When the multipart coupler 100 is installed in the meter breaker 10 between the meter breaker 10 and the MID 50 with the meter breaker 10 and MID 50 powered ON, a significant amount of heat will be generated in the L1 and L2 load pathway portions 151, 152 as power is conducted from the MID 50 to the load side L1 and L2 terminals 18, 19 (via the conductive path formed between the MID-L1 load socket 153 and the load bus connection portion 154 and via the conductive path formed between the MID-L2 load socket 156 and the load bus connection portion 157).

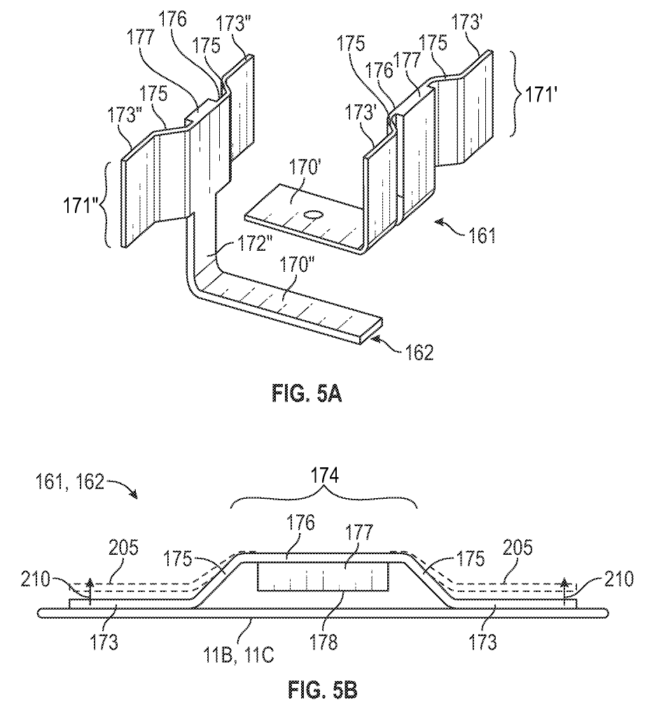

The overmold 160 absorbs heat from the L1 and L2 load pathway portions 151, 152. The heat spreader 161 conducts heat from the overmold 160 to the first side wall 11B (see FIG. 1C). The heat spreader 162 conducts heat from the overmold 160 to the second side wall 11C (see FIG. 1C). The advantageous features of the heat spreaders 161 and 162 are detailed further later herein in conjunction with FIGS. 5A-5B.

Because the heat spreaders 161, 162 engage the side walls 11B, 11C of the meter breaker housing 11, heat is transferred from the L1 and L2 load pathway portions 151, 152 to the side walls 11B, 11C (via the overmold 160 and the heat spreaders 161, 162), enabling some of the heat to dissipate in the environment external to the meter breaker housing 11. This thermal conduction path to the side walls 11B, 11C from the load side electrical joints (i.e. the joints formed between the MID 50 and the branch bus 14) is depicted in FIG. 6. As previously noted, being able to conduct heat from the interior of the meter breaker housing 11 to the exterior is highly advantageous for minimizing the temperature rise all of the electrical joints and the environment inside of the housing 11. The heat spreaders 161, 162 are detailed further later herein in connection with FIGS. 5A-5B.

In conjunction with FIG. 4, reference is made once more to FIG. 3 to detail the alignment template 180. The assembly of the multipart coupler 100 starts with coupling the main grid side L1 coupler 110 to the main L1 terminal 16, coupling the main grid side L2 coupler 130 to the main L2 terminal 17, and coupling the load L1/L2 coupler 150 to the load side L1 and L2 terminals 18, 19, such that each coupler 110, 130, 150 gets coupled to the aforementioned terminals on the meter breaker 10 separately and individually from the other two couplers. The alignment template 180 is a mold formed using the electrical connection side of the MID 50, such that the alignment template 180 replicates the precise locations of the MID electrical terminals that are structured to receive the coupler’s MID-L1 or MID-L2 connecting sockets 115, 135, 153, 156. Specifically, the alignment template 180 comprises a main body 181 having a number of apertures formed therein, including an MID grid-L1 aperture 183 (structured to receive the MID-L1 connecting socket 115), an MID grid-L2 aperture 184 (structured to receive the MID-L2 connecting socket 135), an MID load-L1 aperture 185 (structured to receive the MID-L1 load socket 153), and an MID load-L2 aperture 186 (structured to receive the MID-L2 load socket 156).

Each of the alignment template’s apertures 183, 184, 185, 186 correspond precisely to where the grid side and load L1 and L2 terminals are located on the MID 50, so that when the coupler’s MID-connecting sockets 115, 135, 153, 156 are respectively inserted into the alignment template’s apertures 183, 184, 185, 186, each of the coupler’s MID-connecting sockets will be aligned to connect to the correct corresponding terminal on the MID 50. The alignment template 180 further comprises a coupling protrusion 188 formed in the main body 181 that is structured to be inserted into the template receiving aperture 168 of the load L1/L2 coupler 150, in order to further secure and stabilize the coupling of the alignment template 180 to all of the couplers 110, 130, 150.

Thus, the steps of coupling the MID 50 to the meter breaker 10 using the multipart coupler 100 are as follows: (1) each of the couplers 110, 130, 150 individually get coupled to the corresponding main or load side terminals 16, 17, 18, 19 of the meter breaker 50 as previously detailed herein (and as shown in FIG. 1C); (2) the alignment template 200 gets seated onto the couplers 110, 130, 150 by inserting the couplers’ sockets 115, 135, 153, 156 into the alignment template’s apertures 183, 184, 185, 186, thus forming the complete multipart coupler 100; and (3) finally the MID 50 gets seated onto the multipart coupler 100 by inserting each of the multipart coupler’s sockets 115, 135, 153, 156 into the corresponding grid side and load side terminals of the MID 50 as previously detailed herein. That is, between FIG. 1C and 1D, the alignment template 180 will have been seated on the couplers 110, 130, 150 prior to the MID 50 being seated onto the multipart coupler 100 as shown in FIG. 1D. As previously noted, in addition to providing thermal management for the retrofit MID 50 installed in the meter breaker 10, the multipart coupler 100 also provides important structural support for the MID 50 while it is installed in the meter breaker 100.

Reference is now made to FIG. 5A and FIG. 5B to discuss the advantageous structure of the heat spreaders 161, 162. As can be seen in FIG. 5A, the heat spreaders 161, 162 have generally similar overall structures, with the variations between the structures of each being due to variations in the dimension of certain features rather than having distinct features, as will become apparent in the following discussion of their structures. As such, the same reference numbers are used to refer to features of both heat spreaders 161, 162, with a single prime symbol (i.e. ´ ) being used in the figures to denote the feature of the heat spreader 161 in particular where doing so provides increased clarity, and with a double prime symbol (i.e. ´´ ) being used in the figures to denote the feature of the heat spreader 162 in particular where doing so provides increased clarity. Any component having a reference number with any prime symbols appended can also be referred to generally using the reference number without the prime symbol(s) appended.

Each heat spreader 161, 162 is produced from a thermally conductive material, and in one non-limiting example embodiment of the disclosed concept, each heat spreader 161, 162 is produced from beryllium copper, due to its thermal conductivity properties. Each heat spreader 161, 162 comprises a planar overmold extension portion 170 that extends out from the overmold 160 (FIG. 4) and is coplanar with the overmold 160. Each heat spreader 161, 162 further comprises a wall engaging section l71 that extends orthogonally from the overmold extension portion 170. Due to the geometry of the L2 side of the meter breaker 10, the heat spreader 162 comprises an extra length of conductor 172 that is not necessary and not included in the heat spreader 161. The length of conductor 172 extends between the overmold extension portion 170´´ and the wall engaging portion 171´´.

The wall engaging section 171 comprises two wall engaging wings 173, with each wall engaging wing 173 being planar and disposed orthogonally to the overmold extension portion 170. As shown in FIG. 5B, the wall engaging wings 173 engage the first or second side wall 11B, 11C of the meter breaker housing 11. It will be appreciated that the length of the overmold extension portion 170 is chosen to ensure that the wall engaging wings 173 engage the side wall 11B or 11C. The two wall engaging wings 173 are co-planar but spaced apart, and disposed between the two wall engaging wings 173 is a spring section 174, numbered in FIG. 5B. The spring section 174 comprises two sloped portions 175, with one sloped portion 175 being adjacent to one of the wall engaging wings 173 and the other sloped portion 175 being adjacent to the other wall engaging wing 173. Each sloped portion 175 slopes away from the wall 11B, 11C at a non-orthgonal angle towards the other sloped portion 175, without reaching the other sloped portion 175. Extending between the two sloped portions 175 is a wall parallel portion 176 that is spaced apart from and parallel to the wall 11B, 11C. Extending from the wall parallel portion 176 toward the wall 11B, 11C is an auxiliary thermal contact 177. The auxiliary thermal contact 177 comprises a planar auxiliary contact surface 178 that faces the wall 11B, 11C.

In FIG. 5B, a compressed position 205 of the wall engaging section 171 is depicted in dashed line. The wall engaging portion 171 can be said to be in a compressed position 205 any time the side wall 11B, 11C exerts force in the inward direction 210 (indicated by the arrows 210 in FIG. 5B) on the wall engaging wings 173 and thus pushes the wings 173 closer toward the wall parallel portion 176 than the wings 173 would be in the absence of the external force. With respect to each side wall 11B, 11C, the inward direction 210 indicates a direction oriented away from the side wall 11B, 11C and toward the interior of the meter breaker housing 11. The specific compressed position 205 depicted in FIG. 5B is the position of maximum compression, in which the auxiliary contact surface 178 is co-planar with the wall contacting surfaces of the wall engaging wings 173.

The ability of the heat spreaders 161, 162 to compress is highly advantageous, because the grid side busbars of the meter breaker 10 and the walls of the meter breaker housing 11 are rigid, so if there is any variability in the dimensions of the MID 50 relative to the rigid structures of the meter breaker 10, the heat spreaders 161, 162 can accommodate any such variability by compressing when necessary. In addition, it will be appreciated that increasing the pressure at the points of contact between the heat spreader 161, 162 and the side wall 11B, 11C increases the thermal conduction of heat to the side wall 11B, 11C and away from the electrical joints between the MID 50 and the branch bus 14. Furthermore, to the extent that the wall engaging section 171 of the heat spreader 161, 162 moves into the maximum compressed position 205 (FIG. 5B), this will facilitate maximum thermal conduction from the branch bus 14 to the side wall 11B, 11C due to the auxiliary thermal contact 177 becoming an additional thermal conduction interface with the side wall 11B, 11C.

Reference is now made to FIGS. 7A and 7B, which shows the busbar wall 122, 142 as a laminated busbar wall 122´´, 142´´, and also shows some features of the heat conduction blocks 120, 140 not visible in previous figures. The laminated busbar wall 122´´,142´´ can be made from any thermally conductive material, such as copper, for example and without limitation. As shown in FIG. 7, the conduction blocks 120, 140 further comprise a planar proximal contact plate 126, 146 (not visible in previous figures) that is formed on the proximal conduction plate 121A, 141A. The proximal contact plate 126, 146 is positioned to be directly coupled to the overmold 118, 138 such that the proximal conduction plate 121A, 141A is coupled to the overmold 118, 138 via the proximal contact plate 126, 146. The proximal contact plate 126, 146 robustly prevents against the insertion of dust and moisture into any of the electrical paths. When each busbar wall 122, 142 is a laminated busbar wall 122´´, 142´´, any heat absorbed by the overmold 118 is then conducted to the proximal contact plate 126, 146, then to the proximal conduction plate 121A, 141A, then to the laminated busbar walls 122´´, 142´´, and finally to the distal conduction plate 121B, 141B. It is noted that the proximal and distal conduction plates 121A, 121B, 141A, 141B each comprise an aperture 128, 148 that is visible in FIG. 7A (not visible in the other figures) and structured to receive the respective insulative screws 124, 144 shown in other figures and numbered in FIG. 4.

The laminated busbar walls 122´´, 142´´are flexible, and as can be seen in FIG. 7B, each laminated busbar wall 122´´, 142´´ has a curved profile 127, 147 in a plane orthogonal to the planar surfaces of the proximal and distal conduction plates 121A, 141A, 121B, 141B. As previously noted, the laminated busbar wall 122´´, 142´´ performs similarly to the braided busbar wall 122´,142´ from a thermal conduction perspective. Producing the laminated busbar wall 122´´, 142´´ may, however, provide cost savings in comparison to producing the braided busbar wall 122´,142´.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A multipart coupler for use in installing a retrofit MID into a meter breaker having a meter breaker housing, the multipart coupler comprising:
three component couplers, the three component couplers including:
a main L1 coupler structured to be coupled to a main L1 terminal on a grid side of the meter breaker;
a main L2 coupler structured to be coupled to a main L2 terminal on a grid side of the meter breaker; and
a load L1/L2 coupler structured to be coupled to a load side L1 terminal and a load side L2 terminal on a load side of the meter breaker; and
an alignment template, the alignment template structured to be simultaneously coupled to the three component couplers,
wherein the main L1 coupler is structured to form a grid side L1 thermal conduction path from a joint formed at the main L1 terminal to the meter breaker housing,
wherein the main L2 coupler is structured to form a grid side L2 thermal conduction path from a joint formed at the main L2 terminal to the meter breaker housing, and
wherein the load L1/L2 coupler is structured to form a load side L1 thermal conduction path and a load side L2 thermal conduction path, the load side L1 thermal conduction path extending from a joint formed at the load side L1 terminal to the meter breaker housing, and the load side L2 thermal conduction path being from a joint formed at the load side L2 terminal to the meter breaker housing.

2. The multipart coupler of claim 1,
wherein the grid side L1 thermal conduction path extends from the joint formed at the main L1 terminal to a first wall of the meter breaker housing,
wherein the grid side L2 thermal conduction path extends from the joint formed at the main L2 terminal to the first wall of the meter breaker housing, and
wherein the the load side L1 thermal conduction path extends from the joint formed at the load side L1 terminal to a second wall of the meter breaker housing, and
wherein the load side L2 thermal conduction path extends from the joint formed at the load side L2 terminal to a third wall of the meter breaker housing.

3. The multipart coupler of claim 1,
wherein each of the three component couplers is structured to be coupled to the meter breaker independently of the other component couplers,
where all three component couplers are structured to be coupled to the meter breaker prior to the alignment template being coupled to the three component couplers, and
wherein the alignment template is structured to align electrical connection sockets of the three component couplers with corresponding terminals in the MID.

4. The multipart coupler of claim 3,
wherein the alignment template is a mold formed based on a connection side of the MID.

5. The multipart coupler of claim 1,
wherein the main L1 coupler comprises an L1 grid-to-MID pathway portion, a first overmold that is electrically insulative, and a first heat conduction block,
wherein the L1 grid-to-MID pathway portion is structured to be coupled to the main L1 terminal and includes a L1-MID connecting socket extending from the L1 grid-to-MID pathway portion, the L1-MID connecting socket being structured to be connected to a line side L1 terminal on the MID,
wherein the first overmold is connected between the L1 grid-to-MID pathway portion and the MID-L1 connecting socket,
wherein the first heat conduction block is structured to extend from the first overmold to a wall of the meter breaker housing.

6. The multipart coupler of claim 1,
wherein the main L1 coupler comprises an L1 grid-to-MID pathway portion, a first overmold that is electrically insulative, and a first heat conduction block,
wherein the first heat conduction block comprises a first proximal conduction plate, a first distal conduction plate, and a number of L1 side busbar walls, the first proximal conduction plate being coupled to the first overmold, and the busbar walls extending from the first proximal conduction plate to the first distal conduction plate, and
wherein the first distal conduction plate is structured to engage the first wall.

7. The multipart coupler of claim 5,
wherein the main L2 coupler comprises an L2 grid-to-MID pathway portion, a second overmold that is electrically insulative, and a second heat conduction block,
wherein the L2 grid-to-MID pathway portion is structured to be coupled to the main L2 terminal and includes a L2-MID connecting socket extending from the L2 grid-to-MID pathway portion, the L2-MID connecting socket being structured to be connected to a line side L2 terminal on the MID,
wherein the second overmold is connected between the L2 grid-to-MID pathway portion and the L2-MID connecting socket,
wherein the heat conduction block is structured to extend from the second overmold to the wall of the meter breaker housing.

8. The multipart coupler of claim 6,
wherein the main L2 coupler comprises an L2 grid-to-MID pathway portion, a second overmold that is electrically insulative, and a second heat conduction block,
wherein the second heat conduction block comprises a second proximal conduction plate, a second distal conduction plate, and a number of L2 side busbar walls, the second proximal conduction plate being coupled to the second overmold, and the busbar walls extending from the second proximal conduction plate to the second distal conduction plate, and
wherein the second distal conduction plate is structured to engage the first wall.

9. The multipart coupler of claim 8,
wherein the first heat conduction block further comprises a first number of electrically insulative screws,
wherein the second heat conduction block further comprises a second number of electrically insulative screws,
wherein the first number of electrically insulative screws are configured to be selectively tightened or loosened in order to level the first distal conduction plate against the first wall, and
wherein the second number of electrically insulative screws are configured to be selectively tightened or loosened in order to level the second distal conduction plate against the first wall.

10. The multipart coupler of claim 1,
wherein the load L1/L2 coupler comprises an MID-to-L1 load pathway portion, an MID-to-L2 load pathway portion, an overmold that is electrically insulative, a first heat spreader, and a second heat spreader,
wherein the MID-to-L1 load pathway portion is structured to electrically connect an L1 load terminal of the MID to the load side L1 terminal,
wherein the MID-to-L2 load pathway portion is structured to electrically connect an L2 load terminal of the MID to the load side L2 terminal,
wherein the overmold is coupled to and between the MID-to-L1 load pathway portion and the first heat spreader,
wherein the first heat spreader is structured to extend to the second wall of the meter breaker housing from the overmold,
wherein the overmold is coupled to and between the MID-to-L2 load pathway portion and the second heat spreader, and
wherein the second heat spreader is structured to extend to the third wall of the meter breaker housing from the overmold.

11. The multipart coupler of claim 10,
wherein the first heat spreader comprises a planar overmold extension portion that extends from the overmold to the second wall and is coplanar with the overmold,
wherein the heat spreader comprises a wall engaging section that extends orthogonally from the overmold extension portion and engages the second wall.

12. The multipart coupler of claim 11,
wherein the wall engaging section comprises two wall engaging wings, with each wall engaging wing being planar and disposed orthogonally to the overmold extension portion,
wherein the two wall engaging wings are co-planar and spaced apart,
wherein the wall engaging section comprises a spring section, the spring section including two sloped portions, with one sloped portion being adjacent to one of the wall engaging wings and the other sloped portion being adjacent to the other wall engaging wing,
wherein each sloped portion slopes away from the second wall at a non-orthgonal angle towards the other sloped portion without reaching the other sloped portion, and
wherein a wall parallel portion that is spaced apart from and parallel to the second wall extends between the two sloped portions.

13. The multipart coupler of claim 12,
wherein the wall engaging section is structured to be actuated by the second wall into a compressed position in which the wall engaging wings are pushed closer toward the wall parallel portion than the wings would be in the absence of force exerted by the second wall.

14. The multipart coupler of claim 13,
wherein the wall parallel portion comprises an auxiliary thermal contact that extends from the wall parallel portion toward the second wall,
wherein the auxiliary thermal contact comprises a planar auxiliary contact surface that faces the second wall, and
wherein the compressed position includes a position of maximum compression in which the auxiliary contact surface is coplanar with the wall engaging wings.

15. The multipart coupler of claim 14,
wherein the second heat spreader comprises a planar overmold extension portion that extends from the overmold to the third wall and is coplanar with the overmold, and
wherein the heat spreader comprises a wall engaging section that extends orthogonally from the overmold extension portion, and engages the third wall.

16. The multipart coupler of claim 15,
wherein the wall engaging section comprises two wall engaging wings, with each wall engaging wing being planar and disposed orthogonally to the overmold extension portion,
wherein the two wall engaging wings are co-planar and spaced apart,
wherein the wall engaging section comprises a spring section, the spring section including two sloped portions, with one sloped portion being adjacent to one of the wall engaging wings and the other sloped portion being adjacent to the other wall engaging wing,
wherein each sloped portion slopes away from the second wall at a non-orthgonal angle towards the other sloped portion without reaching the other sloped portion, and
wherein a wall parallel portion that is spaced apart from and parallel to the second wall extends between the two sloped portions.

17. The multipart coupler of claim 16,
wherein the wall engaging section is structured to be actuated by the second wall into a compressed position in which the wall engaging wings are pushed closer toward the wall parallel portion than the wings would be in the absence of force exerted by the second wall.

18. The multipart coupler of claim 17,
wherein the wall parallel portion comprises an auxiliary thermal contact that extends from the wall parallel portion toward the second wall,
wherein the auxiliary thermal contact comprises a planar auxiliary contact surface that faces the second wall, and
wherein the compressed position includes a position of maximum compression in which the auxiliary contact surface is coplanar with the wall engaging wings.

19. The multipart coupler of claim 18,
wherein the first head spreader and the second heat spreader are produced from beryllium copper.

20. The multipart coupler of claim 10,
wherein the MID-to-L1 load pathway portion includes a MID-L1 connecting socket and a first load bus connection portion , the MID-L1 connecting socket being structured to be coupled to a load side L1 terminal of the MID, the first load bus connection portion being structured to be coupled to the load side L1 terminal, and
wherein the MID-to-L2 load pathway portion includes a MID-L2 connecting socket and a second load bus connection portion, the MID-L2 connecting socket being structured to be coupled to a load side L2 terminal of the MID, the second load bus connection portion being structured to be coupled to the load side L2 terminal.
